(19) United States
(12) Patent Application Publication
(10) Pub. No.: US 2003/0196681 A1
(43) Pub. Date: Oct. 23, 2003

(54) Eliminating residual polymer in the cleaning process of post pad etching

(76) Inventors: Ching-Ping Wu, Hsinchu (TW); H. W. Lee, Hsinchu (TW); Szu-Cheng Huang, Hsinchu (TW); Nan-Tzu Lian, Hsinchu (TW); Hsin-Cheng Liu, Hsinchu (TW)

Correspondence Address: POWELL, GOLDSTEIN, FRAZER & MURPHY LLP, P.O. BOX 97223, WASHINGTON, DC, 20090-7223, US

(21) Appl. No.: 10/127,487

(22) Filed: Apr. 23, 2002

(51) Int. Cl. B08B 7/04

(52) U.S. Cl. 134/1.2; 134/26

(57) ABSTRACT

A method for eliminating residual polymers for cleaning etched windows of bonding pads. The invention provides a wafer with etched bonding pad windows that is free of residual polymer. Residual polymers induce an increase in the defect rate of cleaning process and bonding process. The wet stripping process peels Polyimide pieces from the surface of the passivation layer to form residual polymers on the wafer. The present invention utilizes the O₂-ashing process to eliminate the residual polymers on the wafer. The present invention not only prevents Al—F formation on the bonding pads but also eliminates the residual polymers on the wafer. Therefore, the present invention may enhance the yield rate of semiconductor manufacturing by reducing the defect rates. The present invention does not increase the cost of the cleaning process but does increase the quality of the semiconductor.

### FIELD OF THE INVENTION

The present invention relates to a method for eliminating residual polymer on a wafer in the cleaning process of post pads etching. In particular, the present invention relates to the method for reducing the defect rate of the bonding process and enhancing the cleaning process yield rate.

### BACKGROUND OF THE INVENTION

In the manufacture of the semiconductor, the bonding pad is at the interface between the die and the package or the outside world. One side of a wire is soldered to the pad, while the other side of the wire is connected to a lead frame. After all devices and connections are formed on the wafer, a passivation layer is put down onto the wafer surface. This layer seals the device structures in the wafer from contaminants and moisture and also serves as a scratch protection layer. For connecting the pad with the wire to transmit the signal, a plurality of windows is then etched on the passivation layer. Generally, a photolithography process which transfers the pattern from mask to the photoresist on the wafer and an etching process which creates the windows on the passivation layer are used to produce the windows on the wafer. In the etching process, polymer is generated on the sidewalls of the windows of bonding pads. If the polymer peels from sidewalls of the windows, it may cause higher defect rate of the next process thereof. To reduce the defect rate of the manufacturing process, the wafer must be cleaned before the next process.

Normally, the polymer is removed from the wafer in two cleaning processes, wet stripping and dry stripping. Wet stripping uses organic and inorganic photoresist strippers to remove the polymer, e.g. acetone, phenol base, sulfuric acid and H₂ O₂. The strippers may decompose the sidewall polymer and remove it from the wafer. But the inorganic photoresist stripper also corrodes the metal bonding pads. Therefore, the polymer must be removed with organic photoresist stripper when cleaning the sidewall polymer of the bonding pads. The dry stripping process is an O₂-ashing process. The O₂-ashing process is performed under oxygen plasma, which reacts with the sidewall polymer and therefore removes the polymer. The oxygen plasma reacts with the polymer to generate CO, CO₂ and H₂O gases which are drawn out by the exhaust system of the reaction chamber. O₂-ashing may especially reduce the fluorine intensity on the surface of bonding pads. Therefore, the O₂-ashing may prevent Al—F formation and then increase the yield rate of the bonding process because Al—F formations may cause bonding process defects.

Usually, the passivation layer is made of Polyimide which may not only protect the integrated circuit but also releases stress and protects from moisture in package process. In the etching process of the Polyimide passivation layer, the polymers are deposited on the sidewalls of the bonding pads. Since the polymers may peel off and pollute the wafer, it is necessary to remove them. First, a dry stripping process, O₂-ashing, is conducted to prevent Al—F formations from forming on the bonding pads. Second, a wet stripping process with the hydroxylamine (HDA) base chemical solutions, e.g. the photoresist stripper EKC and ACT, is conducted to clean the wafer surface. But residual polymers may exist on the wafer surface even after the wet stripping process. The inspection requirements of the cleaning process are becoming increasingly strict for improving the quality of the bonding process. Therefore, two defect rates are increasingly high; one is the defect rate of the cleaning process and the other is the defect rate of bonding process. Accordingly, an improved cleaning process which reduces the defect rate of the cleaning process and bonding process is needed.

FIG. 1 is schematic top view of a residual polymer on a semiconductor after the etching process for bonding pad windows and cleaning process. A residual polymer 20 is stuck to the center of wafer 10. The square holes near the boundary are bonding pads 30.

FIG. 2 shows a flow chart for a cleaning process according to the prior art. After the devices of integrated circuits have been formed, a passivation layer, e.g. a Polyimide passivation layer, is put down onto the wafer surface and then the bonding pads pattern is transferred onto the Polyimide layer by photolithography. Step 210 indicates the etching of the bonding pad windows on the passivation layer. Step 220 uses the dry stripping process, O₂-ashing, to protect the metal pads from fluoride metal formation, e.g. Al—F formation. Step 230 uses the wet stripping process with the wet stripper, a hydroxylamine based chemical solution as EKC and ACT photoresist stripper, to remove the polymer from the wafer surface. Finally, step 240 utilizes a rinsing process to clean the wafer, e.g. a quick dump rinse process.

### SUMMARY OF THE INVENTION

One object of this invention is to provide an improved cleaning process which eliminates the residual polymer on the wafer.

Another object of the invention is to provide an improved cleaning process that reduces the defect rate of the cleaning and bonding process.

In the first aspect, the invention provides a method of eliminating residual polymers for cleaning etched windows of bonding pads, the method comprising etching said windows on a passivation layer of a wafer, stripping polymers created in the etching step on said wafer with a wet stripping process, stripping said residual polymers on said wafer with a dry stripping process, and rinsing said wafer.

In a second aspect, the invention provides a method of eliminating residual polymers for cleaning etched windows of bonding pads of a Polyimide passivation layer of a wafer, the method comprising stripping polymers created in the process of etching windows on said wafer with a wet stripping process using a hydroxylamine base chemical solution, stripping said residual polymers on said wafer with a O₂-ashing process, and rinsing said wafer.

### BRIEF DESCRIPTION OF THE DRAWINGS

The foregoing aspects and many of the attendant advantages of this invention will become more readily appreciated as the same becomes better understood by reference to the following detailed description, when taken in conjunction with the accompanying drawings, wherein:

FIG. 1 is a schematic top view of a residual polymer on a semiconductor after the etching process and cleaning process;

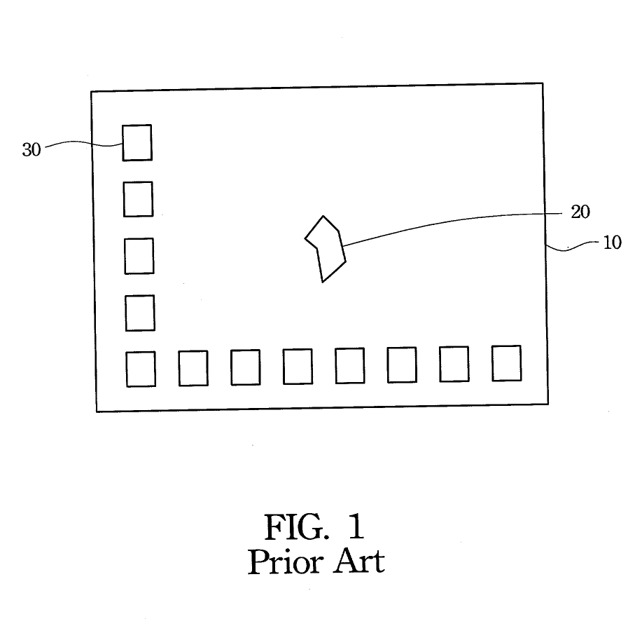

FIG. 2 is a flow chart for a cleaning process according to the prior art;

FIG. 3 is a flow chart for a cleaning process according to the present invention; and

FIG. 4 is a table comparing cleaning process results of the present invention and different conventional cleaning processes.

### DETAILED DESCRIPTION OF THE PREFERRED EMBODIMENT

In view of description in the background of the invention, the residual polymer may cause a higher defect rate for a cleaning process and a higher defect rate for a bonding process. The whys and wherefores of the residual polymer on the wafer are found after repeated changing of the process parameters and practical changing process. The residual polymers are generated in two manufacturing processes. The first process is the etching process of bonding pad windows and the second process is O₂-ashing, dry stripping process. The surface characters of the Polyimide passivation layer are changed by the two processes, and therefore the following process, wet stripping, peeling Polyimide pieces from the surface of the passivation layer to form residual polymer on the wafer. Because the wet strippers, e.g. EKC and ACT photoresist strippers, are hydroxylamine (HDA)-based chemical solutions with etching capability, they not only remove the polymer on the wafer surface but also etch the Polyimide passivation layer to form residual polymer.

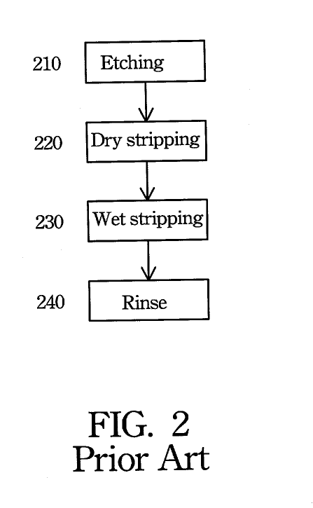

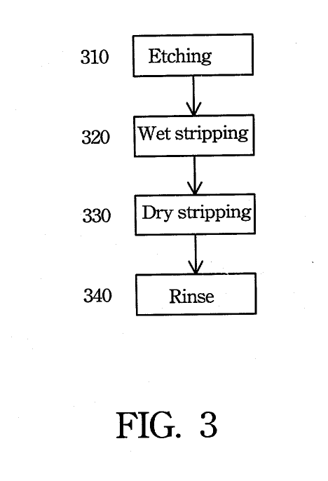

FIG. 3 shows a flow chart for a cleaning process according to the present invention. The differences between FIG. 2 and FIG. 3 are two steps. Step 320, a wet stripping process, is the same as step 230 and step 330, a dry stripping process, is the same as step 220. That is to say, the process in FIG. 3 changes the sequence of step 220 and step 230 in the process of FIG. 2.

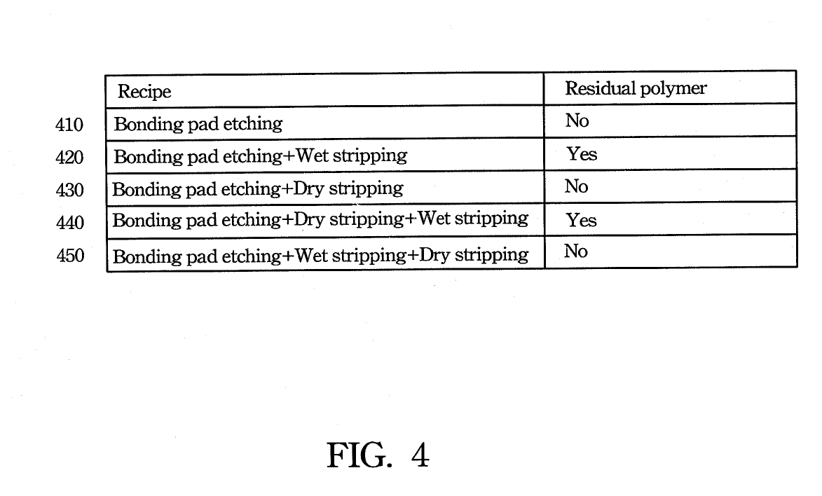

To further disclose the process according to the present invention, FIG. 4 shows a chart comparing cleaning process results of the present invention and different cleaning processes. The residual polymers pollute the wafer surface and induce defects in different processes. Referring to process 410, the passivation layer passes through an etching process only and there is no peeled polymer. In process 420, the passivation layer passes through etching and wet stripping processes and residual polymers are found on the wafer surface. In process 430, an etching process and dry stripping process with Oxygen plasma are performed and no residual polymer is found on the wafer surface. In process 440, etching, dry stripping and wet stripping processes are performed and a serious amount of residual polymers is found on the wafer surface. Finally, in process 450, etching, wet stripping and dry stripping processes are performed and no residual polymer is found on the wafer surface. Therefore, the conclusions are that the wet stripping process induces the surface of passivation layer to peel, the O₂-ashing process enhances the peeling phenomenon of passivation layer when it occurs before the wet stripping process and the O₂-ashing process may eliminate the residual polymer on the wafer surface. That is to say, using the process in accordance with the present invention not only protects the metal bonding pads fluoride formation, e.g. Al—F formation, by reducing the fluorine intensity on the surface of the pads but also eliminates the residual polymer on the wafer.

The present invention changes wet stripping and dry stripping in the cleaning process only, but utilizes O₂-ashing with capacities of the eliminating the polymer and protecting the metal pads. The present invention adds nothing to the cost of the cleaning process but does improve the quality of the semiconductor. Therefore, the present invention provides a great contribution to semiconductor manufacture. As is understood by a person skilled in the art, the foregoing preferred embodiments of the present invention are illustrative of the present invention rather than limiting of the present invention. It is intended that various modifications and similar arrangements be included within the spirit and scope of the appended claims, the scope of which should be accorded the broadest interpretation so as to encompass all such modifications and similar structures.

What is claimed is:

1. A method of eliminating residual polymers resulted from etching contact windows of bonding pads on a wafer, the method comprising:
stripping away polymers created in the etching process with a wet stripping process;
stripping away said residual polymers with a dry stripping process; and
rinsing said wafer.

2. The method according to claim 1, wherein the wet stripping process utilizes a hydroxylamine-based chemical solution to strip away said polymers on said wafer.

3. The method according to claim 2, wherein the hydroxylamine-based chemical solution further comprises an EKC photoresist stripper.

4. The method according to claim 2, wherein the hydroxylamine-based chemical solution further comprises an ACT photoresist stripper.

5. The method according to claim 1, wherein the dry stripping process utilizes an O₂-ashing process with Oxygen plasma to strip away said residual polymers.

6. The method according to claim 5, wherein the O₂-ashing process reduces fluorine intensity on said bonding pads.

7. The method according to claim 1, wherein the step of rinsing said wafer is a Quick Dump Rinse process.

8. The method according to claim 1, wherein the polymers created in the etching step form on sidewalls of said windows.

9. The method according to claim 1, wherein the residual polymers further comprise pollutants formed from said polymers created in the etching step and polymers peeled from said passivation layer.

10. A method of eliminating residual polymers, which is used to clean etched windows of bonding pads of a Polyimide passivation layer of a wafer, the method comprising:
stripping away polymers created in a process of etching windows on said wafer with a wet stripping process using a hydroxylamine-based chemical solution;
stripping away said residual polymers on said wafer with an O₂-ashing process; and
rinsing said wafer.

11. The method according to claim 10, wherein the hydroxylamine-based chemical solution further comprises an EKC photoresist stripper.

12. The method according to claim 10, wherein the hydroxylamine-based chemical solution further comprises an ACT photoresist stripper.

13. The method according to claim 10, wherein the O₂-ashing process utilizes Oxygen plasma to strip said residual polymers and reduces fluorine intensity on said bonding pads.

14. The method according to claim 10, wherein the step of rinsing said wafer is a Quick Dump Rinse process.

15. The method according to claim 10, wherein the polymers created in the etching process form on sidewalls of said windows.

16. The method according to claim 10, wherein the residual polymers further comprise pollutants formed from said polymers created in a process of etching windows and polymers peeled from said passivation layer.
